(19) United States
(12) Patent Application Publication
(10) Pub. No.: US 2015/0142688 A1
(43) Pub. Date: May 21, 2015

(54) DONATION MANAGEMENT, PROMOTION, AND FUNDS DISTRIBUTION METHODS AND SYSTEMS

(71) Applicant: Switch Commerce, L.L.C., Irving, TX (US)

(72) Inventors: Jerry Jackson, Fort Worth, TX (US); Walter James Ochenski, III, Corinth, TX (US)

(21) Appl. No.: 14/539,548

(22) Filed: Nov. 12, 2014

Related U.S. Application Data
(60) Provisional application No. 61/902,914, filed on Nov. 12, 2013.

(51) Int. Cl. G06Q 30/02

(52) U.S. Cl. CPC G06Q 30/0279
USPC 705/329

(57) ABSTRACT

A process for collecting and distributing to multiple beneficiaries funds donated by multiple donors, including the steps of presenting to a donor a group of potential beneficiaries to which the donor may donate, providing to the donor a beneficiary selection means through use of which the donor may select one or more beneficiaries for effecting a donation, and providing the donor with access to a payment means through use of which the donor may make a payment to a fund managed by a process manager. The process further includes associating by the process manager the payment with the one or more selected beneficiaries, generating and transmitting to the donor a receipt means for memorializing the payment, creating a donor record in an automated records storage system that includes donor-identifying information, the donor's selected beneficiaries, and the associated amount of the payment by the donor, and generating beneficiary notification means for notifying the one or more selected beneficiaries that donated funds have been deposited for the selected beneficiaries' intended benefit and providing information on fund-retrieving steps for claiming the donated funds.

### STATEMENT OF PRIORITY

The present application claims priority to U.S. Provisional Application No. 61/902,914, titled “Donation Management, Promotion, and Funds Distribution Methods And Systems” and filed Nov. 12, 2013.

### TECHNICAL FIELD

The present invention relates to electronic commerce and financial transactions systems and methods.

### BACKGROUND

Charitable giving is an essential element of society at-large. In many societies, including that of the United States of America, donation-funded organizations perform innumerable societal functions that are essential to life as we know it. Donation-funded organizations and services touch virtually every sector of life, and play essential roles in education, health care, child and elder care, scientific and medical research, the exercise of religious beliefs and associated duties, environmental protection, psychological assistance, community enhancement, entertainment, disaster relief, societal issues awareness, and public safety (among many others).

Charitable giving enables far more than any government, at any applicable tax structure, would or could provide, without which society as we know it would not exist. Nor would many of us exist, because of the life-saving effects of much that is funded by charitable giving (of example of countless others being that of donations—funded St. Jude Children's Hospital to whom many owe their very lives).

A threat to charitable giving comes (indirectly, at least) from a surprising source—one that in most quarters makes life easier, and if properly harnessed, can facilitate and enhance charitable giving as well. Technology, including computers, mobile phones, electronic communications and transactions, and the like all help or facilitate most functions in life. In most contexts, users consider two particular features of modern life—the replacement of paper mail with email and paper checks mailed to a payee with electronic checks—to represent an unqualified step forward. However, for a donation-based organization that historically have been, and today largely remain dependent on direct, in-person or mailed donation models, involving cash or mailed checks, the ever-accelerating move to e-commerce threaten their life blood of donations. This is simply because their donors (if typical of most in modern society) are less and less of the habit of having cash or checkbook at-hand, and even less so of dealing with physical mail. Donations become an ever-easier “I'll get around to that next week” category of tasks for busy donors. This is especially true if writing a check, getting a stamp, and physically mailing a donation is the only engagement in this kind of transaction (paper check and physical mail) that the would-be donor will need to have (their other transactions, perhaps, all occurring on-line, or through some other form of e-commerce, automated draft, etc.).

However stated: it is essential for charitable organizations that donating be made “easy” for donors, and “easy” means, at least in part, compatible with donors' tastes and transactional habits. Better still if donors can be reminded in a targeted, demographically-tailored, timely manner in such ways that donors are motivated when they can best be motivated. And even better still if donors' satisfaction is heightened to the greatest degree possible by interactions and incentives that can only be tailored and timed in a manner made possible by automation, electronic communications, and the like.

Another challenging reality facing any charitable organization is that of overhead. Donations-related overhead can represent a substantial budget line item. Donations management costs pertain to accounting, donor acknowledgement (including expressions of appreciation and providing tax receipts), donor-follow-up, records keeping for organizational reporting and tax-exemption purposes, costs for physical media and mailing, and budgeting and projections. Another, significant cost to charitable organizations not known to many (particularly donors, to whom these costs are invisible, though they erode their donations) are transactional charges relating to such things as credit card-based donation payments.

Because, after a point, money not spent is just as meaningful as donated money coming in, anything that can reduce a charitable organization's overhead can directly impact their ability to deliver according to their mission.

Creating or maintaining visibility among the numerous charitable organizations that vie for donor dollars is itself a significant challenge for charitable organizations. This is particularly true for reaching and creating awareness in the minds of donors who are looking for a cause to support—an increasingly common feature of the emerging younger generation of donors and potential donors. An attractive presence in any donor-frequented listing or “menu” or presentation of “Apps” presenting charitable causes is essential for any charitable organization to survive and thrive, particularly as donor habits, mindsets and senses of credibility continue to evolve.

Finally, donors often contribute for the benefit of tax deductions and require proper tax statements or receipts associated with their charitable giving. Consistently receiving and managing these tax statements from a wide variety of tax deductible organizations or events can be challenging for contributors, hindering a donor's ability to maximize charitable giving deductions across multiple organizations such as an individual's, church, school or contributions made at charity events, especially where smaller donations are often overlooked in situations where a receipt or giving statement is not immediately provided by charitable organizations.

Taking all of the above into consideration, any charitable organization will benefit (as well as those whom it serves) from any method, system or process that (to the greatest degree possible for that organization and its donors): (1) establishes, promotes, increases and maintains awareness in existing and prospective donors' minds of the organization, its mission and its needs; (2) makes donating as effortless for donors and consistent with lifestyles and habits of donors as is possible; (3) facilitates time-specific, location-dependent, and/or donor-tailored communications between donors and an organization; (4) reduces donor and donation management costs; (5) reduces transactions costs and, as a result, increases effective donation amounts; (6) provides donors with a single cloud based, online and mobile application solution that helps them to be more aware of a wide variety of organization events and communications via mobile application notifications of various events, cause or other fundraising campaigns across multiple organizations; and (7) tracks donor giving statements and receipts for tax purposes, aggregating reporting for all donations made to multiple participating organizations by charity and cause.

### SUMMARY OF THE INVENTION

The present disclosure introduces various illustrative embodiments for collecting and distributing to multiple beneficiaries funds donated by multiple donors.

It is an object of the present disclosure to provide a process for collecting and distributing to multiple beneficiaries funds donated by multiple donors, including the steps of presenting to a donor a group of potential beneficiaries to which the donor may donate, providing to the donor a beneficiary selection means through use of which the donor may select one or more beneficiaries for effecting a donation, and providing the donor with access to a payment means through use of which the donor may make a payment to a fund managed by a process manager. The process further includes associating by the process manager the payment with the one or more selected beneficiaries, generating and transmitting to the donor a receipt means for memorializing the payment, creating a donor record in an automated records storage system that includes donor-identifying information, the donor's selected beneficiaries, and the associated amount of the payment by the donor, and generating beneficiary notification means for notifying the one or more selected beneficiaries that donated funds have been deposited for the selected beneficiaries' intended benefit and providing information on fund-retrieving steps for claiming the donated funds.

It is another object of the present disclosure to provide a non-transitory computer-readable storage medium storing instructions for collecting and distributing to multiple beneficiaries funds donated by multiple donors that, when executed by one or more processors, cause the one or more processor to perform operations including presenting to a donor a group of potential beneficiaries to which the donor may donate, providing to the donor a beneficiary selection means through use of which the donor may select one or more beneficiaries for effecting a donation, and providing the donor with access to a payment means through use of which the donor may make a payment to a fund managed by a process manager. The instructions further cause the one or more processors to perform operations of enabling association by the process manager the payment with the one or more selected beneficiaries, generating and transmitting to the donor a receipt means for memorializing the payment, creating a donor record in an automated records storage system that includes donor-identifying information, the donor's selected beneficiaries, and the associated amount of the payment by the donor, and generating beneficiary notification means for notifying the one or more selected beneficiaries that donated funds have been deposited for the selected beneficiaries' intended benefit and providing information on fund-retrieving steps for claiming the donated funds.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 depicts a system for implementing donation management, promotions, and funds distribution, according to one or more embodiments.

FIG. 2 is a block diagram of computing device that may be employed in the system of FIG. 1, according to one or more embodiments

FIG. 3 illustrates a flow diagram of an illustrative method for implementing donation management, promotions, and funds distribution, according to one or more embodiments.

### DETAILED DESCRIPTION

The present disclosure introduces various illustrative systems and methods for collecting and distributing to multiple beneficiaries funds donated by multiple donors.

The present disclosure enables an improvement in the field of giving and donations by enabling a new, flexible, convenient, and efficient giving solutions. In particular, the present disclosure (1) establishes, promotes, increases and maintains awareness in existing and prospective donors' minds of the organization, its mission and its needs; (2) makes donating as effortless for donors and consistent with lifestyles and habits of donors as is possible; (3) facilitates time-specific, location-dependent, and/or donor-tailored communications between donors and an organization; (4) reduces donor and donation management costs; (5) reduces transactions costs and, as a result, increases effective donation amounts; (6) provides donors with a single cloud based, online and mobile application solution that helps them to be more aware of a wide variety of organization events and communications via mobile application notifications of various events, cause or other fundraising campaigns across multiple organizations; and (7) tracks donor giving statements and receipts for tax purposes, aggregating reporting for all donations made to multiple participating organizations by charity and cause.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

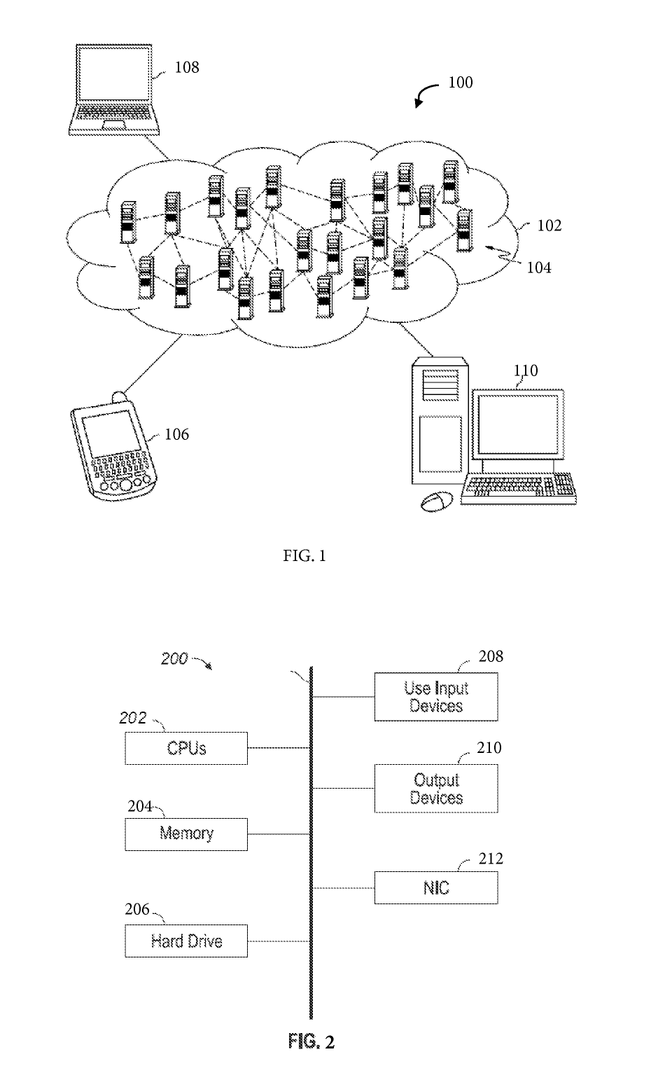

FIG. 1 depicts a system 100 for implementing donation management, promotions, and funds distribution, according to one or more embodiments. The system 100 comprises a network 102 that includes one or more network computers 104 (e.g., servers, databases, and the like), wherein each of the network computers 104 is capable of communicating, directly or indirectly, with each other. In some embodiments, and as depicted, the system 100 represents a “cloud” computing system as known to those skilled in the art.

The system 100 further includes additional computing devices capable of communicating with the network 102 and network computers 104. As depicted, such devices may include, for example and without limitation, a cellular telephone 106 (e.g., a smart phone), PDA device, tablet computer, or the like. Further devices may include a laptop computer 108 and/or a desktop computer 110. Communication between the devices 106, 108, and 110 and the network 102 may be “hard-wired” or wireless, for example via wireless Ethernet, cellular communications, or the like as known to those skilled in the art. It will be appreciated by those skilled in the art that the devices shown in FIG. 2 (e.g. phone 106, laptop 108, and desktop 110), along with the particular configuration of network computers 104 are intended to be illustrative only and that the system 100 may include more or fewer of each.

Briefly referring to FIG. 2, depicted is a block diagram of a computing device 200 that may be employed in the present disclosure, according to one or more embodiments. For example, the computing device 200 may be representative of one or all of the networking computers 104, and/or the phone 106, laptop 108, and/or desktop computer 110 depicted and described in FIG. 1.

As depicted, the computing device 200 includes one or more processors or CPUs 202, memory 204, and a hard drive 206. The computing device 200 further includes user input devices 208, output devices 210, and a network interface card (NIC) or device 212, all of which is electrically coupled together by a bus 214.

The CPUs 202 may include, for example and without limitation, one or more processors, (each processor having one or more cores), microprocessors, field programmable gate arrays (FPGAs), application specific integrated circuits (ASICs) or other types of processing units that may interpret and execute instructions as known to those skilled in the art. The memory 204 includes non-transitory computer-readable storage medium of any sort (volatile or non-volatile) as known to those skilled in the art. User input devices 208 may include, for example and without limitation, a keyboard, mouse, touchscreen, or other similar input devices. Exemplary output devices 210 may include, for example and without limitation, monitors, tablet or PDA screens, wireless communication device screens, printers, and the like.

The NIC 212 enables the computing device 200 to interact with other computing devices. For example, each of the networking computers 104 to interact with each other, and additionally with any of the phone 106, laptop 108, and/or desktop computer 110. One of skill in the art will appreciate that the NIC 212 may enable physical communication between various devices via hard wire, or may alternatively enable wireless communication (e.g., via wireless network signals or cellular signals).

Referring now back to FIG. 1, in one exemplary operation and embodiment, the system 100 may be employed for collecting and distributing to multiple beneficiaries funds donated by multiple donors. For example, the non-transitory computer-readable storage medium (e.g., memory 204) of the network computers 104 and/or the devices 106, 108, and 110 may operate independently or in conjunction to store instructions which, when executed by one or more processors (e.g. CPUs 202) of the network computers 104 and/or the devices 106, 108, and 110, cause the one or more processors to perform operations that include presenting to a donor a group of potential beneficiaries to which the donor may donate. The instructions may further be executed to provide the donor with a beneficiary selection means through use of which the donor may select one or more beneficiaries for effecting a donation.

For example, the donor may be using the wireless phone 106 that includes a downloaded program or “app”. Such app or program may enable the donor to login and save detailed donor information (or donor characteristics), including name, email, gender, birthday, etc. The app presents the donor with the group of potential beneficiaries in an organized fashion, such as a list or table, for selection. In some embodiments, the donor may be able to employ a search function of the app to find a particular beneficiary. In other embodiments, the app may remember recently viewed beneficiary organizations, beneficiaries the donor has given to before, or beneficiaries currently near the donor. From the app, the donor may select one or more of the beneficiaries to give a donation to. Upon selecting a beneficiary, further information may be displayed to the donor, such as particular funds (e.g., a “general fund,” a “building fund,” a “mission fund”, and the like), preset quantities to donate to those funds, and further information regarding the beneficiary in general (i.e., their mission and values), upcoming events, and links to their social media sites.

Alternatively, or in addition thereto, the app (or a webpage) may provide a visual depiction of the donor's donations. For example, the app may display one or more charts, graphs, or both with categories or particular beneficiaries and associated donations. Other details, such as a full donation list, scheduled donations, and donation receipts may also be accessed via the app or webpage.

The instructions further provide the donor with access to a payment means through use of which the donor may make a payment to a fund managed by a process manager. For example, the website or mobile app may enable the donor to enter credit card information, bank information, a paypal login, or the like. The instructions further enable association by the process manager of the payment with the one or more selected beneficiaries. Upon selection of one or more beneficiaries, donation of funds by the donor, and processing of such payment, the instructions may execute to generate and transmit to the donor a receipt means for memorializing the payment.

Example receipt means in some embodiments may be electronic receipts transferred via email or text to the donor. Alternatively, in further embodiments, the app may receive the receipts and thereby keep track of them for easy organization and later recall by the donor (e.g., when doing taxes, to track how much was donated during a given year). In some embodiments, the instructions may automatically generate and transmit the receipt, advantageously, eliminating the need for human processing, and the possibility of human errors, such as mistyping numbers into the receipt. Moreover, automation of such a process reduces the time for a donor to receive such a receipt, as it is generated nearly instantaneously.

Further execution of the instructions creates a donor record in an automated records storage system that includes donor-identifying information, the donor's selected beneficiaries, and the associated amount of the payment by the donor. The automated storage system may be part of the same network 102, or a separate network. Such donor-identifying information may be, for example and without limitation, a donor's address, email, phone number, or fax number. The instructions may further generate beneficiary notification means for notifying the one or more selected beneficiaries that donated funds have been deposited for the selected beneficiaries' intended benefit and providing information on fund-retrieving steps for claiming the donated funds. For example, the system may email, fax, or text the beneficiary with such fund-retrieving steps, for example, instructing the beneficiary to login to the website or mobile application to claim the donated funds.

In further embodiments, the donor record includes donor characteristics information and donor communications-enabling information. Such donor characteristic information may include properties, for example and without limitation, such as characteristics of the donor—how much the donor makes, their annual donations, what type of profession they are in, etc. Donor communication-enabling information may include information capable of enabling communication with the donor, such as a phone number, mailing address, email address, and the like.

Moreover, the automated records storage systems may include communications means for transmitting and receiving electronic communications, with the beneficiary notification means being transmitted by such communications means. As previously discussed, such communication means include varieties of both wired and wireless type communications.

The instructions may further be executed to search for and retrieve the donor record, as may be performed by a variety of algorithms, indexing techniques, and the like as known to those skilled in the art. Moreover, the instructions enable the donor to enter characteristic information, for example into an input box of the app, and then, upon entering of such information, associate such characteristic information with the donor. The instructions may further merge such entered information with the donor's already defined record stored on the network 102, and additionally transmit the entire record back to the donor for viewing. In some embodiments, the instructions may create a human-readable donor transaction record that aggregates and displays to a donor information pertaining to one or more of the donor's payment transaction. For example, the app may keep a list, chart, or graph, or a combination thereof displaying the donors transaction record. The display be enable the donor to sort by beneficiary, amount donated, date donated, or the like, thereby enabling flexibility and ease of use for the donor.

In some embodiments, the instructions may provide access by a selected beneficiary to all or portions of the donor record via restricted access means. Such restricted access means may be software implemented, such as a login by the beneficiary to the system, or a specific granting of access to a beneficiary by the donor. Additionally, the instructions may provide beneficiary-selectable donor information actuation means (e.g. inputs previously described, such as a mouse, keyboard, touchscreen on a cellular phone or tablet, or other devices enabling user input and interaction) for selecting one or more portions of the donor record for effecting one or more beneficiary-donor interaction steps, including generation of beneficiary-specific donor communications to the donor, transmission of which is conditioned upon the selection of a beneficiary-defined communications prerequisite.

In further embodiments, the instructions may actuate donor communication device recognition means at a beneficiary-selected geographic location or multiple locations for effecting donor presence steps upon recognition, using portions of the donor information, a proximity donor, who is in proximity to the donor communication device recognition means. In other words, beneficiaries may select one or more locations in which they would like to communicate with potential donors, and such communication will be disbursed to the potential donors if the donor is within a proximity to that location. This may also be known as using “geo-referencing” or “geofencing” technology.

For example, the donor communication means may be cellular telephone 106, thereby enabling the donor to receive texts, calls, and emails. Upon the donor cellular telephone 106 coming within proximity of the beneficiary selected geographic location, for example, based on GPS signal or triangulation of the phone's location, and dependent on a portion of the donor information, the cell phone may alert the donor of the beneficiary near them and the ability to donate. Such geofencing is not humanly possible to accomplish, especially on a large-scale basis, and possibly in multiple locations simultaneously. However, advantageously, such geofencing enables friendly, yet efficient reminders to only those who may be in the beneficiaries designated areas, thus enabling an easy method and reminder for donors to donate which is anything but routine, as prior methods of reminders typically involved spamming all donors (and/or potential donors) on a beneficiaries contact list.

The program may be capable of allowing geofencing to occur only within a desired date range (in other words, an “active” date range). Additionally, the program may enable control by the beneficiary of which geofencing areas the donor is subscribed to, for example, the mobile app. Moreover, the program may be capable of detecting which messages have been disbursed, thus assuring current messages are being sent, even to those who are just entering the geofenced location. Furthermore, the program may be capable of detecting whether a person is “entering” or “exiting” the geofenced area, thereby enabling different messages to be disbursed to the donor accordingly. For example, if a donor is entering the geofencing range, a welcome or introductory message with information about the beneficiary may be sent. However, if the donor is leaving, a farewell message may be sent.

Moreover, in other embodiments, the donor communication device is interfaced with the automated records storage system, thereby enabling associated communications between the donor and beneficiary. Based on the donor-identifying information in the automated records storage system, the process may transmit beneficiary-donor communication to the donor, such as delivering a text or email to the donor informing (or reminding them) about the beneficiary. The process may also transmit communication to a beneficiary that reflects some or all of the donor-identifying information, for example, informing a beneficiary of a particular donor's age or profession.

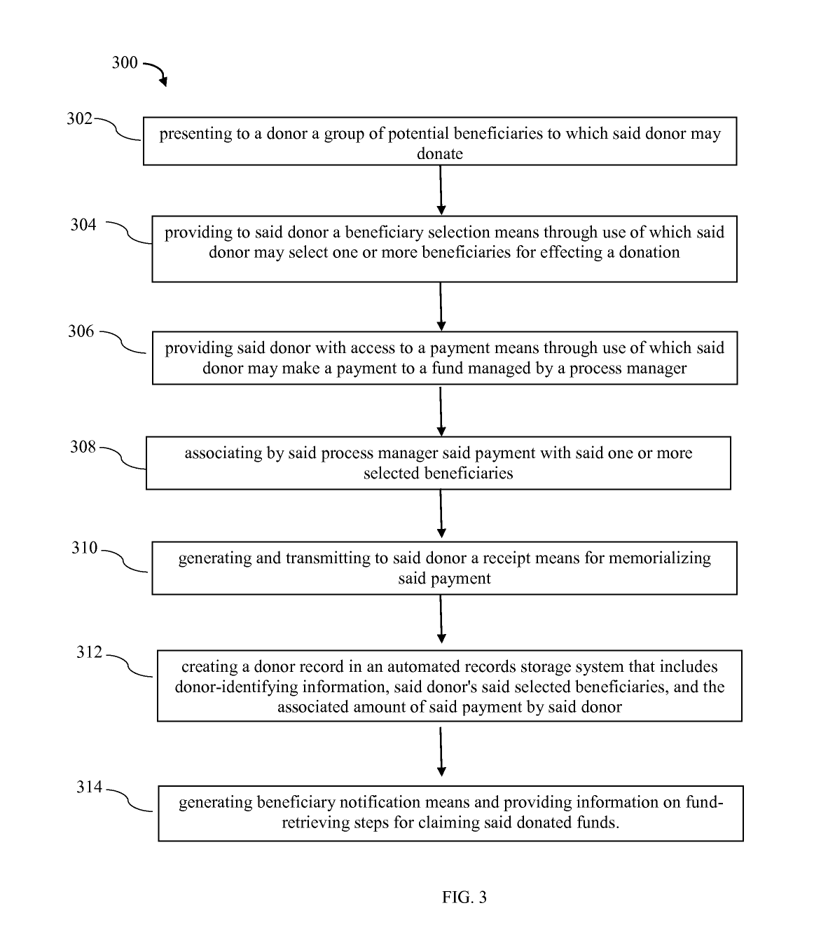

FIG. 3 illustrates a flow diagram of an illustrative method 300 for implementing donation management, promotions, and funds distribution, according to one or more embodiments. In one embodiment, the method 300 may be implemented on a system similar to system 100 (FIG. 1) which may employ a program on a network (possibly on a cloud network) and enables various platforms and devices to interact therewith. As the system (e.g., system 100) includes hard drives and memory (e.g., hard drive 206 and memory 204), it may function, and thus be referenced herein, as an automated records storage system. Moreover, the method 300 may be implemented on, and executed by, a variety of devices, including wireless phones, PDA's, tablets, personal computers, and the servers previously described. The method 300 may be implemented via, for example and without limitation, an “app” that may be downloaded on certain devices (e.g., wireless phone or tablet computer) and/or a website which may be logged onto from anywhere and any machine that has access to the world wide web. Such an app and/or website may be similar to that discussed above, and therefore will not be described in detail again.

At block 302, a donor is presented with a group of potential beneficiaries to which the donor may donate. Such presentation may be a full listing of beneficiaries, or alternatively a drop-down list of beneficiaries to select from, or furthermore a searchable list for which the donor can enter all or part of a beneficiary name to search. At block 304, the donor is provided with a beneficiary selection means through use of which the donor may select one or more beneficiaries for effecting a donation. Such means may be, for example and without limitation, a webpage or mobile device application including a selectable list as previously discussed. The donor is capable of selecting a single beneficiary or multiple beneficiaries

At block 306, the method 300 provides the donor with a payment means through use of which the donor may make a payment to a fund managed by a process manager. For example, the website or mobile app may enable the donor to enter credit card information, bank information, a paypal login, or the like. At block 308, the process manager may associate the payment with the selected one or more beneficiaries. At block 310, a receipt is generated and transmitted to the donor, thereby memorializing payment made to the one or more beneficiaries. Example receipt means in some embodiments may be electronic receipts transferred via email or text to the donor. In further embodiments, the app may receive the receipts and thereby keep track of them for easy organization and later recall by the donor (e.g., when doing taxes, to track how much was donated during a given year). In some embodiments, the software running on the network servers (e.g., network computers 104) automatically generates and transmits the receipt, advantageously, thereby eliminating the need for human processing, and the possibility of human error of mistyping numbers in the receipt. Moreover, automation of such a process reduces the time for a donor to receive such a receipt, as it is generated nearly instantaneously.

At block 312, the system acts as an automated records storage system and generates a donor record therein, wherein the donor record includes donor-identifying information, the donor's selected beneficiaries, and the amount of payment by the donor to each beneficiary. Such donor-identifying information may be, for example and without limitation, a donor's address, email, phone number, or fax number. At block 314, the method 300 employs a beneficiary notification means for providing information on fund-retrieving steps for claiming the donated funds. For example, the system may email, fax, or text the beneficiary with such fund-retrieving steps, for example, instructing the beneficiary to login to the website or mobile application to claim the donated funds.

In other embodiments, the method 300 may further include saving donor characteristics information and donor communications-enabling information as a part of the donor record. Such donor characteristic information may include properties, for example and without limitation, such as characteristics of the donor—how much the donor makes, their annual donations, their profession, etc. Donor communication-enabling information may include information capable of enabling communication with the donor, such as a phone number, mailing address, email address, and the like. Moreover, the automated records storage system further includes a communications means for transmitting and receiving electronic communications, wherein the beneficiary notification means are transmitted employing such. As previously discussed, such communication means include varieties of both wired and wireless type communications.

The automated records storage system further includes a means for searching for and retrieving the donor record. For example, the automated records storage system may include search functionality, possibly enabling search by amount given, date given, donor characteristics or donor identifying information.

The automated records storage system further includes a means for user-actuation of one or more portions of the donor characteristics information (i.e., a donor entering characteristics information), whereby a user-defined donor communication is thereby associated with the donor. Upon the donor communication being entered (e.g. via keyboard, smart phone screen, or other user input), the automated records storage system associates the donor communication with the donor, and further may merge the donor communication with the donor record. Afterwards, the donor communication may be transmitted to the donor.

In further embodiments, the method 300 includes a human-readable donor transaction record that aggregates and displays to the donor information pertaining to one or more of the donor's payment transactions. For example, the display may be a printout or output via a monitor output of a computer screen or cell phone display. The donor may be capable of filtering which payment transactions they would prefer to view, including filtering by beneficiary, donation amount, donation date, etc.

In other embodiments, the system may provide access by a selected beneficiary to all or a portion of the donor records via restricted access means. Such restricted access means may be software implemented, such as a login by the beneficiary to the system, or a specific granting of access to a beneficiary by the donor. Additionally, the system may provide beneficiary-selectable donor information actuation means (e.g. inputs previously described, such as a mouse, keyboard, touchscreen on a cellular phone or tablet, or other devices enabling user input and interaction) for selecting one or more portions of the donor record for effecting one or more beneficiary-donor interaction steps, including generation of beneficiary-specific donor communications to the donor, transmission of which is conditioned upon the selection of a beneficiary-defined communications prerequisite.

In further embodiments, the method 300 may further include actuating donor communication device recognition means at a beneficiary-selected geographic location or multiple locations for effecting donor presence steps upon recognition, using portions of the donor information, a proximity donor, who is in proximity to the donor communication device recognition means. In other words, beneficiaries may select one or more locations in which they would like to communicate with potential donors, and such communication will be disbursed to the potential donors if the donor is within a proximity to that location. This may also be known as using “geo-referencing” or “geofencing” technology.

For example, the donor communication means may be a cell phone, wherein the donor may receive texts, calls, and emails. Upon the donor cell phone coming within proximity of the beneficiary selected geographic location, for example, based on GPS signal or triangulation of the phone's location, and dependent on a portion of the donor information, the cell phone may alert the donor of the beneficiary near them and the ability to donate. Such geofencing is not humanly possible to accomplish, especially on a large-scale basis, and possibly in multiple locations simultaneously. However, advantageously, such geofencing enables friendly, yet efficient reminders to only those who may be in the beneficiaries designated areas, thus enabling an easy method and reminder for donors to donate which is anything but routine, as prior methods of reminders typically involved spamming all donors (and/or potential donors) on a beneficiaries contact list.

The method 300 may be capable of allowing geofencing to occur only within a desired date range (in other words, an “active” date range). Additionally, the method 300 may enable control by the beneficiary of which geofenced areas the donor is subscribed to from, for example, the mobile app. Moreover, the method 300 may be capable of detecting which messages have been disbursed, thus assuring current messages are being sent, even to those who are just entering the geofenced location. Furthermore, the method 300 may be capable of detecting whether a person is “entering” or “exiting” the geofenced area, thereby enabling different messages to be disbursed to the donor accordingly. For example, if a donor is entering the geofencing range, a welcome or introductory message with information about the beneficiary may be sent. However, if the donor is leaving, a farewell message may be sent. The method may also enable donation reminders or scheduling, such as on a weekly or monthly basis, or allow reoccurring donations as desired.

Moreover, in other embodiments, the donor communication device is interfaced with the automated records storage system, thereby enabling associated communications between the donor and beneficiary. Based on the donor-identifying information in the automated records storage system, the process may transmit beneficiary-donor communication to the donor. The process may also transmit communication to a beneficiary that reflects some or all of the donor-identifying information.

As mentioned above, at block 310, a receipt is generated and transmitted to the donor, thereby memorializing payment made to the one or more beneficiaries. Additionally, in some embodiments, the method 300 may further include a means for providing the donors with a tax statement for each of the beneficiaries which the donor has donated to. Such may be implemented, for example and without limitation, by tax statements from each beneficiary being associated with the donor and being stored in the automated records storage system. In other embodiments, the software may independently determine or estimate the tax receipts and/or tax consequences for the donor's donations.

In further embodiments, the method 300 may, through automated beneficiary qualification means, qualify one or more of the potential beneficiaries according to pre-selected criteria, and actuate the automated records storage system for applying qualifying processing rates to financial transactions between the potential beneficiaries and the process manager. In some embodiments, the payment means may include at least one of a credit card, digital check, or debit card means.

In even further embodiments, the method 300 may further include a means for providing a link to a social media page for each potential beneficiary of the group of potential beneficiaries. Such a means may include enabling the potential beneficiary to post a link on a website or on the beneficiary's page within an app (used on cellular, tablet, or portable devices).

Although the disclosure has been described and illustrated with respect to exemplary objects thereof, it will be understood by those skilled in the art that various other changes, omissions, and additions may be made therein and thereto without departing from the scope of the present disclosure.

What is claimed is:

1. A process for collecting and distributing to multiple beneficiaries funds donated by multiple donors, comprising the steps of:
presenting to a donor a group of potential beneficiaries to which said donor may donate;
providing to said donor a beneficiary selection means through use of which said donor may select one or more beneficiaries for effecting a donation;
providing said donor with access to a payment means through use of which said donor may make a payment to a fund managed by a process manager;
associating by said process manager said payment with said one or more selected beneficiaries;
generating and transmitting to said donor a receipt means for memorializing said payment;
creating a donor record in an automated records storage system that includes donor-identifying information, said donor's said selected beneficiaries, and the associated amount of said payment by said donor; and
generating beneficiary notification means for notifying said one or more said selected beneficiaries that donated funds have been deposited for said selected beneficiaries' intended benefit and providing information on fund-retrieving steps for claiming said donated funds.

2. The process of claim 1 wherein:
said donor record includes donor characteristics information and donor communications-enabling information;
said automated records storage systems comprising:
communications means for transmitting and receiving electronic communications, said beneficiary notification means being transmitted by said communications means, and further comprises means for:
searching for and retrieving said donor record;
user-actuation of one or more portions of said donor characteristics information, and associating a user-defined donor communication with said donor, conditioned upon an actuation state of said one or more portions of said donor characteristics information;
associating and generating said user-defined donor communication;
merging information from said donor record with said user-defined donor communication; and
after said merging information from said donor record with said user-defined donor communication, transmitting said donor communication to said donor.

3. The process of claim 1, further comprising the step of creating a human-readable donor transactions record that aggregates and displays to a donor information pertaining to one or more of said donor's payment transactions.

4. The process of claim 2, further comprising the step of creating a human-readable donor transactions record that aggregates and displays to said donor via a computer interface information pertaining to one or more of said donor's payment transactions.

5. The process of claim 1, further comprising the steps of:
providing access by a said selected beneficiary to all or portions of said donor record via restricted access means;
providing beneficiary-selectable donor information actuation means for selecting one or more portions of said donor record for effecting one or more beneficiary-donor interaction steps, said one or more beneficiary-donor interaction steps comprising:
generation of beneficiary-specific donor communications to said donor, transmission of which is conditioned upon the selection of a beneficiary-defined communications prerequisite.

6. The process of claim 1, further including the step of:
actuating donor communication device recognition means at a beneficiary-selected geographic location or multiple locations for effecting donor presence steps upon recognition, using portions of said donor information, of a said donor, a proximity donor, who is in proximity to said donor communication device recognition means.

7. The process of claim 6, wherein said donor communication device recognition means is interfaced with said automated records storage system and said donor presence steps comprise one or more of:
associating said proximity donor with donor-identifying information in said automated records storage system and generating a said beneficiary-donor communication for transmission to said proximity donor; and
associating said proximity donor with donor-identifying information in said automated records storage system and generating a communication to a beneficiary that reflects some or all of said donor-identifying information.

8. The process of claim 2, further including the step of:
actuating donor communication device recognition means at a beneficiary-selected geographic location or multiple locations for effecting donor-presence steps upon recognition, using portions of said donor information, of a said donor, a proximity donor, who is in proximity to said donor communication device recognition means.

9. The process of claim 8, wherein said donor communication device recognition means is interfaced with said automated records storage system and said donor presence steps comprise one or more of:
associating said proximity donor with donor-identifying information in said automated records storage system and generating a said beneficiary-specific donor communication for transmission to said proximity donor; and
associating said proximity donor with donor-identifying information in said automated records storage system and generating a communication to a beneficiary that reflects some or all of said donor-identifying information.

10. The process of claim 5, further including the steps of:
actuating donor communication device recognition means at a beneficiary-selected geographic location or multiple locations for effecting donor-presence steps upon recognition, using portions of said donor information, of a said donor, a proximity donor, who is in proximity to said donor communication device recognition means.

11. The process of claim 10, wherein said donor communication device recognition means is interfaced with said automated records storage system and said donor presence steps comprise one or more of:
associating said proximity donor with donor-identifying information in said automated records storage system and generating a said beneficiary-specific donor communication for transmission to said proximity donor; and
associating said proximity donor with donor-identifying information in said automated records storage system and generating a communication to a beneficiary that reflects some or all of said donor-identifying information.

12. The process of claim 1, further comprising providing a means for providing said donors with a tax statement for each of said beneficiaries that said donor has donated to.

13. The process of claim 1, further comprising the step of:
through automated beneficiary qualification means, qualifying one or more of said potential beneficiaries according to pre-selected criteria and actuating said automated records storage system for applying qualifying processing rates to financial transactions between said potential beneficiaries and said process manager.

14. The method of claim 1, further comprising a means for providing a link to a social media page for each potential beneficiary of said group of potential beneficiaries.

15. A non-transitory computer-readable storage medium storing instructions for collecting and distributing to multiple beneficiaries funds donated by multiple donors that, when executed by one or more processors, cause said one or more processor to perform operations comprising:
presenting to a donor a group of potential beneficiaries to which said donor may donate;
providing to said donor a beneficiary selection means through use of which said donor may select one or more beneficiaries for effecting a donation;
providing said donor with access to a payment means through use of which said donor may make a payment to a fund managed by a process manager;
enabling association by said process manager of said payment with said one or more selected beneficiaries;
generating and transmitting to said donor a receipt means for memorializing said payment;
creating a donor record in an automated records storage system that includes donor-identifying information, said donor's said selected beneficiaries, and the associated amount of said payment by said donor; and
generating beneficiary notification means for notifying said one or more said selected beneficiaries that donated funds have been deposited for said selected beneficiaries' intended benefit and providing information on fund-retrieving steps for claiming said donated funds.

16. The non-transitory computer-readable storage medium storing instructions of claim 15:
wherein said donor record includes donor characteristics information and donor communications-enabling information,
wherein said automated records storage systems comprises communications means for transmitting and receiving electronic communications, said beneficiary notification means being transmitted by said communications means,
and wherein the computer readable medium further includes program code for causing the one or more process to perform operations comprising a means for:
searching for and retrieving said donor record;
enabling user-actuation of one or more portions of said donor characteristics information, and associating a user-defined donor communication with said donor, conditioned upon an actuation state of said one or more portions of said donor characteristics information;
associating and generating said user-defined donor communication;
merging information from said donor record with said user-defined donor communication; and
after said merging information from said donor record with said user-defined donor communication, transmitting said donor communication to said donor.

17. The non-transitory computer-readable storage medium storing instructions of claim 15, further comprising program code for causing the one or more process to perform operations of creating a human-readable donor transactions record that aggregates and displays to a donor information pertaining to one or more of said donor's payment transactions.

18. The non-transitory computer-readable storage medium storing instructions of claim 15, further comprising program code for causing the one or more process to perform operations of:
providing access by a said selected beneficiary to all or portions of said donor record via restricted access means;
providing beneficiary-selectable donor information actuation means for selecting one or more portions of said donor record for effecting one or more beneficiary-donor interaction steps, said one or more beneficiary-donor interaction steps comprising:
generation of beneficiary-specific donor communications to said donor, transmission of which is conditioned upon the selection of a beneficiary-defined communications prerequisite.

19. The non-transitory computer-readable storage medium storing instructions of claim 15, further comprising program code for causing the one or more process to perform operations of:
actuating donor communication device recognition means at a beneficiary-selected geographic location or multiple locations for effecting donor presence steps upon recognition, using portions of said donor information, of a said donor, a proximity donor, who is in proximity to said donor communication device recognition means.

20. The non-transitory computer-readable storage medium storing instructions of claim 19, further comprising program code for causing the one or more process to perform operations of:
associating said proximity donor with donor-identifying information in said automated records storage system and generating a said beneficiary-donor communication for transmission to said proximity donor; and
associating said proximity donor with donor-identifying information in said automated records storage system and generating a communication to a beneficiary that reflects some or all of said donor-identifying information.
